(19) United States
(12) Patent Application Publication
(10) Pub. No.: US 2025/0386815 A1
(43) Pub. Date: Dec. 25, 2025

(54) SOUNDING STRUCTURE OF SPINNING FISHING REEL

(71) Applicant: OKUMA FISHING TACKLE CO., LTD., Taichung City (TW)

(72) Inventors: Liang-Jen CHANG, Taichung City (TW); Jyun-Jie LIAO, Taichung City (TW)

(73) Assignee: OKUMA FISHING TACKLE CO., LTD., Taichung City (TW)

(21) Appl. No.: 18/753,439

(22) Filed: Jun. 25, 2024

(51) Int. Cl. A01K 89/01

(52) U.S. Cl. CPC A01K 89/0123

(57) ABSTRACT

A sounding structure of a spinning fishing reel includes a spindle, a dial disk sleeved onto the spindle in a non-rotatable manner relative to the spindle, a line spool, and a tension clip. The line spool is sleeved onto the spindle in a rotatable manner relative to the spindle and provided with a tube portion. The tension clip has a curved shape with at least one protruding portion engaged into an annular groove of the line spool in a way that the tension clip is non-rotatable relative to the line spool, and an elastic arm extending outwardly from the at least one protruding portion in a way that the elastic arm is in contact with an undulating portion of the dial disk. As such, the sounding structure has a simple structure with fewer component, thereby facilitating assembly, reducing costs and enhancing market competitiveness.

### BACKGROUND OF THE INVENTION

### 1. Field of the Invention

The present invention relates generally to a fishing tackle and more particularly, to a sounding structure of a spinning fishing reel.

### 2. Description of the Related Art

The spinning fishing reel is a common type of fishing reel, which includes a housing, a line spool reciprocatingly moveable in front of the housing, a rotor rotatably installed between the line spool and the housing, and a handle rotatably installed on one side of the housing. The rotor is driven to rotate by the handle, and the line spool is driven by the handle to reciprocatingly move back and forth. By rotating the handle, the fishing line can be evenly wound onto the line spool.

When a fish is hooked and attempts to escape, it may pull the fishing line out of the line spool. To alert the user that the fishing line is being pulled out by a fish, a sounding device is generally equipped with the line spool to generate a warning sound, such as a ticking sound, when the line spool rotates. This warning sound alerts the user to perform subsequent line retrieval actions. However, the conventional sounding device has a relatively complex structure, requiring screws for fastening purpose and the installation of springs and sounding pieces, resulting in time-consuming in assembly and difficulty in cost reduction.

### SUMMARY OF THE INVENTION

The present invention has been accomplished in view of the above-noted circumstances. It is an objective of the present invention to provide a sounding structure of a spinning fishing reel, which has a simple structure, fewer components, and is easy to assemble, thereby reducing costs and enhancing market competitiveness.

To attain the above-mentioned and other objectives, the present invention provides a sounding structure of a spinning fishing reel, comprising a spindle, a dial disk, a line spool, and a tension clip. The dial disk includes a disk body sleeved onto the spindle in a non-rotatable manner relative to the spindle, and an undulating portion at a periphery of the disk body. The line spool is sleeved onto the spindle in a rotatable manner relative to the spindle, and includes a tube portion and an annular groove disposed on an inner periphery of the tube portion. The tension clip has a curved shape with at least one protruding portion engaged into the annular groove of the line spool in a way that the tension clip is non-rotatable relative to the line spool, and an elastic arm extending outwardly from the at least one protruding portion in a way that the elastic arm is in contact with the undulating portion of the dial disk. As such, the sounding structure has a simple structure with fewer components, thereby facilitating assembly, reducing costs and enhancing market competitiveness.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a spinning fishing reel in accordance with a first preferred embodiment of the present invention;

FIG. 2 is an exploded view of a sounding structure of the spinning fishing reel of the first preferred embodiment of the present invention;

FIGS. 3 and 4 are sectional views of the sounding structure of the spinning fishing reel of the first preferred embodiment of the present invention;

FIG. 5 a perspective view of a sounding structure of a spinning fishing reel according to a second preferred embodiment of the present invention;

FIG. 6 is a perspective view of a sounding structure of a spinning fishing reel according to a third preferred embodiment of the present invention; and

FIG. 7 is a front view of a sounding structure of a spinning fishing reel according to a fourth preferred embodiment of the present invention.

### DETAILED DESCRIPTION OF THE INVENTION

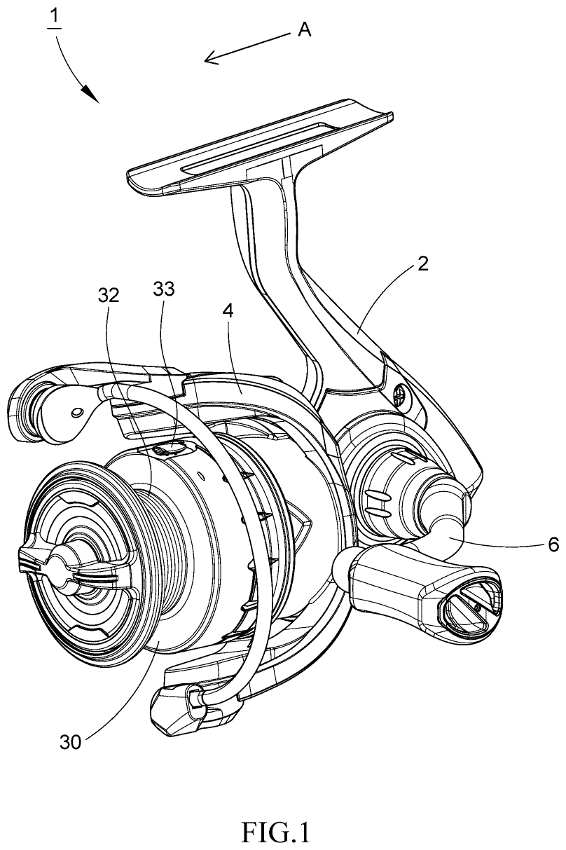

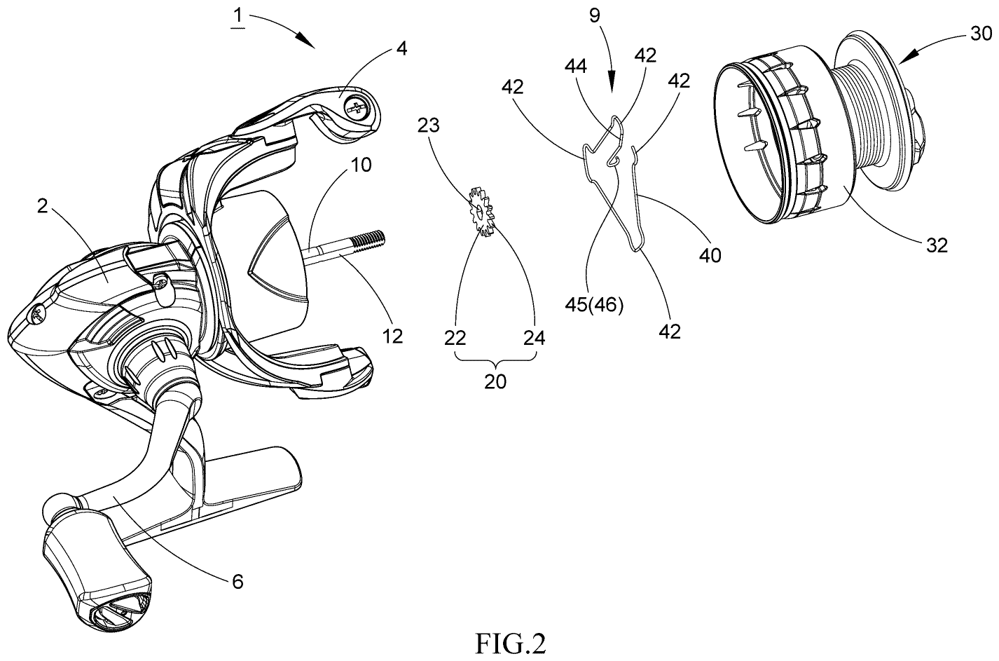

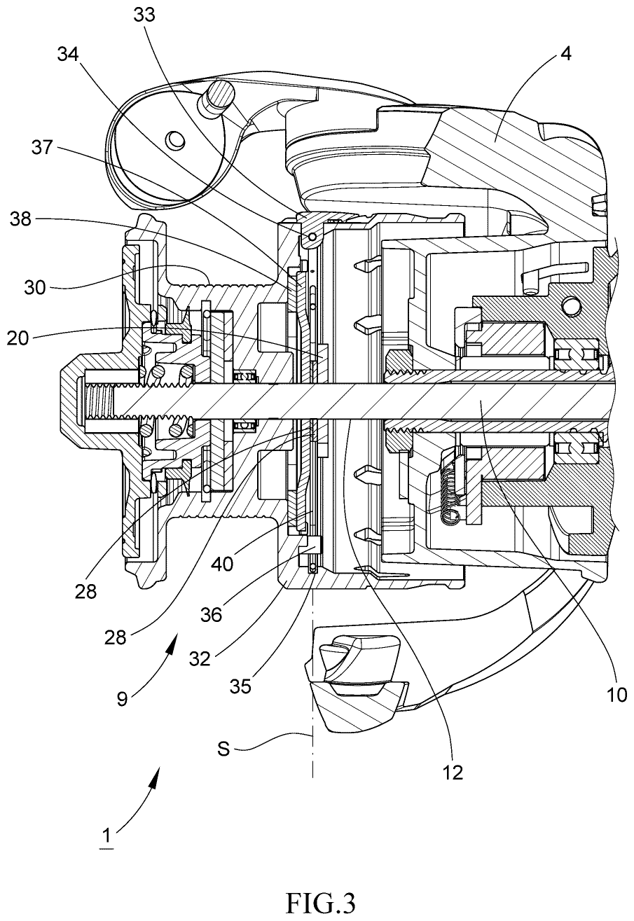

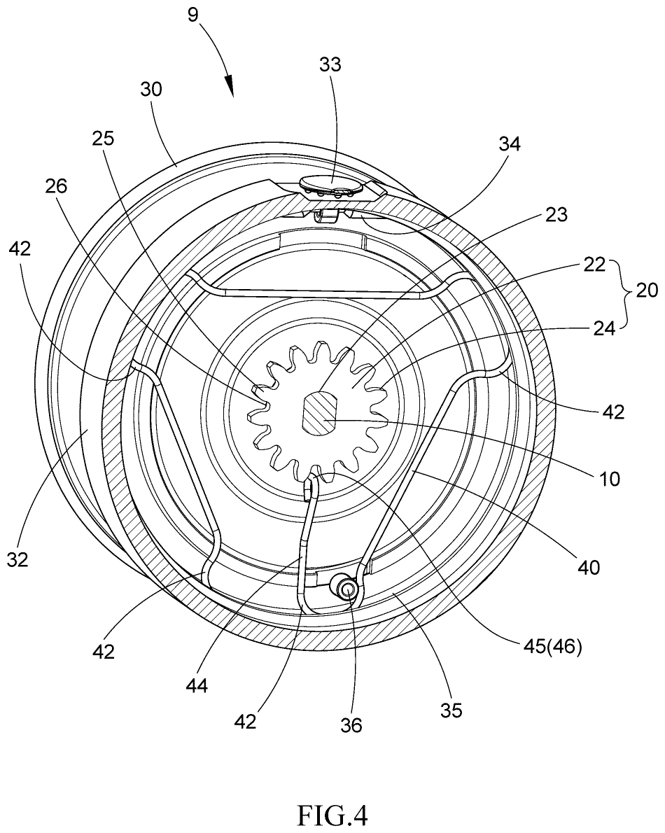

Hereunder four preferred embodiments will be detailedly described with accompanying drawings for illustrating technical features and structure of the present invention. FIGS. 1-4 illustrate a sounding structure 9 of a spinning fishing reel 1 provided in accordance with a first preferred embodiment of the present invention. The spinning fishing reel 1 is mainly composed of a housing 2, a spindle 10, a dial disk 20, a line spool 30 reciprocatingly moveable in front of the housing 2, a rotor 4 rotatably installed between the line spool 30 and the housing 2, a handle 6 rotatably installed on one side of the housing 2, and a tension clip 40. For convenience of illustration, the arrow A indicated in FIG. 1 is taken as the front direction, but this is not a limitation on the scope of the present invention.

The spindle 10 is located inside the housing 2. When the handle 6 rotates, it drives the spindle 10 to reciprocatingly move back and forth. The front section 12 of the spindle 10 has a non-circular cross-section.

The dial disk 20 has a disk body 22 and an undulating portion 24. The disk body 22 is sleeved onto the spindle 10 in a manner that the disk body 24 is non-rotatable relative to the spindle 10. The undulating portion 24 is provided at the periphery of the disk body 22. In this embodiment, the disk body 22 is circular and has a non-circular shaft hole 23, which is sleeved onto the front section 12 of the spindle 10. The undulating portion 24 has a plurality of peaks 25 and a plurality of troughs 26, which are arranged alternately in a serrated manner. There is no limitation on the shape of the undulating portion 24, as long as it is non-circular.

The line spool 30 is sleeved onto the spindle 10 in a manner that the line spool 30 is rotatable relative to the spindle 10. The line spool 30 has a tube portion 32 and an annular groove 35 disposed on the inner periphery of the tube portion 32. The tube portion 32 of the line spool 30 is equipped with a line hooking member 33 having an inner end that is connected with a first anti-rotation member 34. The first anti-rotation member 34 partially extends into the annular groove 35 of the line spool 30. The tube portion 32 of the line spool 30 is designed to wind the fishing line (not shown) thereon. To provide appropriate friction to counteract the pull force of the hooked fish on the fishing line, a keyed washer 37 and a brake washer 38 are provided. Specifically speaking, the keyed washer 37 is sleeved onto the spindle 10 and located between the tension clip 40 and the line spool 30. The brake washer 38 is sleeved onto the spindle 10 and located between the keyed washer 37 and the line spool 30. The keyed washer 37 is designed as being not rotatable relative to the spindle 10, whereas the brake washer 38 is not restricted by the spindle 10. When the line spool 30 is pressed against the brake washer 38 due to the action of other components, the keyed washer 37, which is supported by the dial disk 20 and two washers 28, cannot move. Thus, the line spool 30 gains a predetermined rotational friction due to the action of the brake washer 38.

The tension clip 40 has a strip-like curved shape to provide a predetermined outward expanding tension. In this embodiment, the tension clip 40 includes four protruding portions 42 that are extended into and firmly engaged with the annular groove 35 of the line spool 30, and an elastic arm 44 extending from one of the protruding portions 42 towards the center in such a way that the elastic arm 44 is in contact with the undulating portion 24 of the dial disk 20. Since the tension clip 40 and the first anti-rotation member 34 are both located in the annular groove 35, and the first anti-rotation member 34 is connected to the line hooking member 33 such that the first anti-rotation member 34 cannot move, the tension clip 40 is restricted by the first anti-rotation member 34 in such a manner that the tension clip 40 cannot rotate relative to the line spool 30. The distal end 45 of the elastic arm 44 has an axial segment 46 that extends into one of the troughs 26 of the dial disk 20. The extending direction of the axial segment 46 is parallel to the spindle 10. However, in other embodiments, the distal end 45 only needs to be engaged with the undulating portion 24. In other words, the axial segment 46 may be omitted. Additionally, two or more protruding portions 42 may be sufficient.

When a fish is hooked and attempts to escape to pull the fishing line out of the line spool 30, the line spool 30 rotates relative to the spindle 10 and the dial disk 20, and the tension clip 40 rotates along with the line spool 30, resulting in that the elastic arm 44 is continuously flicked by the peaks 25 of the undulating portion 24 of the dial disk 20, producing intermittent sounds. These sounds alert the user that a fish is hooked and further actions, such as reeling in, are needed. With the above disclosed structural features, the sounding structure 9 of the spinning fishing reel 1 provided by the present invention has a simple structure with few components. Furthermore, the assembly task requires only slight compression of the tension clip 40 to fit the tension clip 40 into the annular groove 35 of the line spool 30, and then releasing the tension clip 40 to allow the tension clip 40 to expand outward and therefore lock with the line spool 30. This eliminates the need for screws or installation of springs and sounding pieces as in conventional structures, making assembly very convenient. These advantageous features can effectively reduce costs and enhance market competitiveness, achieving the objective of the present invention.

To ensure that the tension clip 40 does not rotate relative to the line spool 30, a second anti-rotation member 36, which is realized as a cylindrical pillar in this embodiment, may be additionally installed with the line spool 30. The annular groove 35 of the line spool 30 is located on an imaginary plane S, and the second anti-rotation member 36 intersects with this imaginary plane S, providing a stop for the tension clip 40 located on the imaginary plane S, thereby preventing the tension clip 40 from rotating relative to the line spool 30. It should be noted that the first anti-rotation member 34 and the second anti-rotation member 36 may be considered as types of anti-rotation members and can be selectively installed. However, the first and second anti-rotation members 34 and 36 may be omitted, and in this condition, the tension chip 40 can still rotate together with the line pool 30 by relying solely on the friction between the tension clip 40 and the annular groove 35.

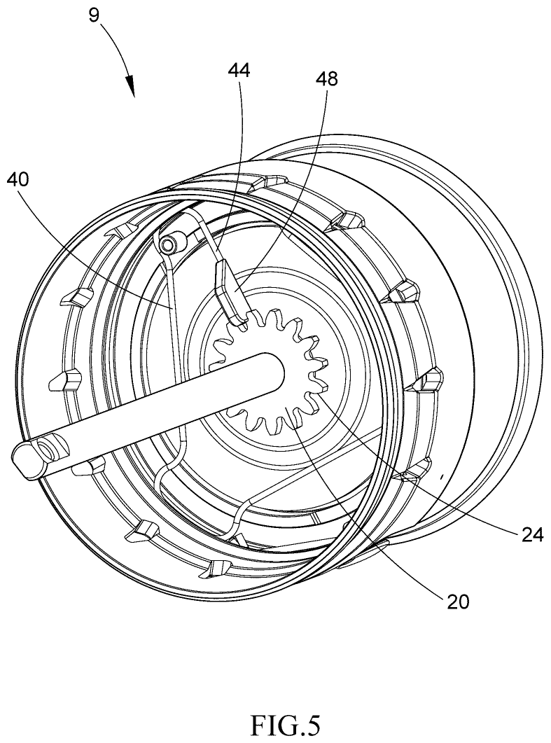

Based on the above-discussed structural features, various modifications to the sounding structure 9 of the spinning fishing reel 1 may be made. For example, FIG. 5 depicts a sounding structure 9 of a spinning fishing reel 1 provided by a second preferred embodiment of the present invention, which is generally structurally the same as the first embodiment, with the difference lying in that the elastic arm 44 of the tension clip 40 is provided with a striking member 48 at its distal end 45 in such a way that the striking member 48 is stopped against the undulating portion 24 of the dial disk 20. By means of using various materials to make the striking member 48, different warning sounds can be produced. Furthermore, by using the striking member 48, the sounding structure 9 may have excellent wear resistance and prolonged service life.

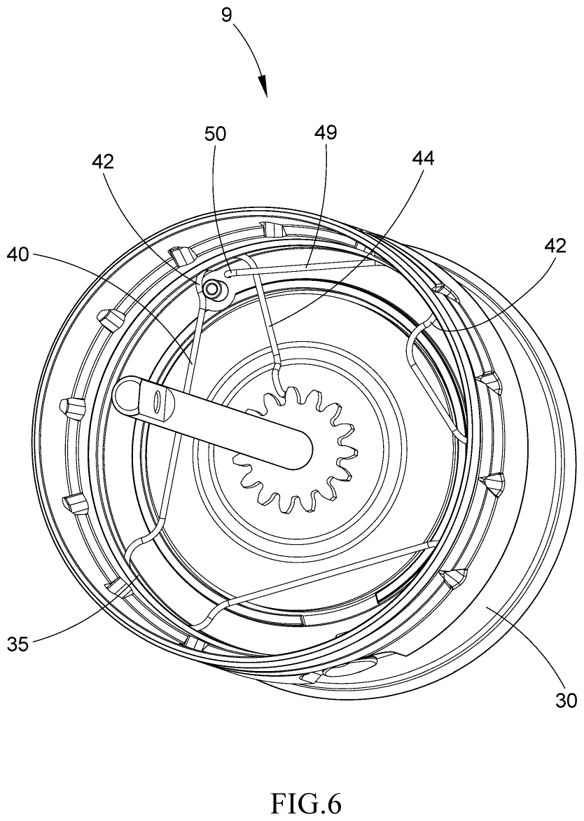

Furthermore, FIG. 6 depicts a sounding structure 9 of a spinning fishing reel 1 provided by a third preferred embodiment of the present invention, which is generally structurally the same as the first embodiment, with the difference lying in that the tension clip 40 further has a stop arm 49 extending from one of the protruding portions 42 and overlappingly engaging with the elastic arm 44. Specifically speaking, the stop arm 49 is pressed on the elastic arm 44, which can prevent the tension clip 40 from escape from the annular groove 35 of the line spool 30 due to continuous vibration of the elastic arm 44. To make the overall structure more stable, a hook portion 50 extending from the distal end of the stop arm 49 is further provided.

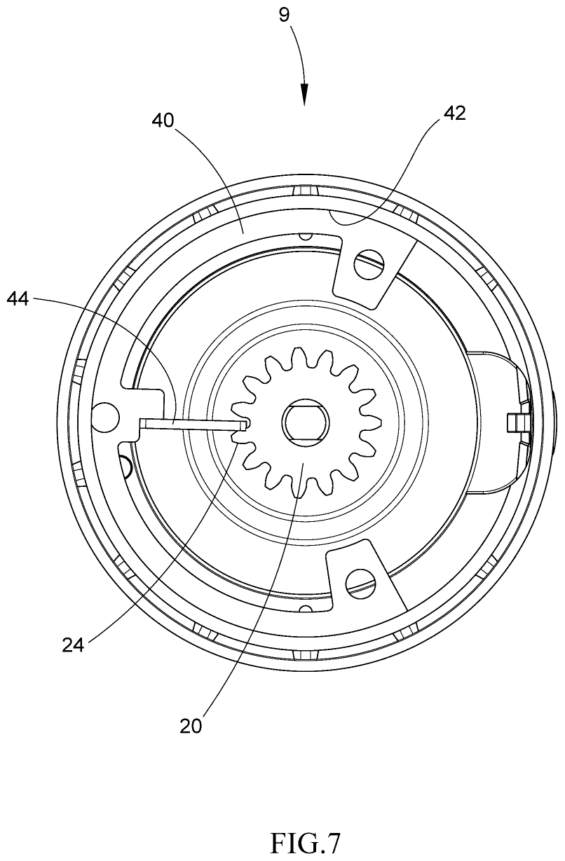

Moreover, FIG. 7 depicts a sounding structure 9 of a spinning fishing reel 1 provided by a fourth preferred embodiment of the present invention, which is generally structurally the same as the first embodiment, with the difference lying in that the tension clip 40 is realized as a C-shaped clip, i.e., C-shaped retainer, which is generally curved in a flat strip shape. It can be regarded as having only one protruding portion 42 extending over more than half of the circumference, and the elastic arm 44 extends from the center of the protruding portion 42 towards the dial disk 20 in a way that the distal end of the elastic arm 44 is engaged with the undulating portion 24.

Any such easily conceivable structural changes mentioned above should be within the scope of the claims of the present invention.

What is claimed is:

1. A sounding structure of a spinning fishing reel, the sounding structure comprising:
a spindle;
a dial disk, including a disk body sleeved onto the spindle in a non-rotatable manner relative to the spindle, and an undulating portion at a periphery of the disk body;
a line spool, sleeved onto the spindle in a rotatable manner relative to the spindle, the line spool including a tube portion and an annular groove disposed on an inner periphery of the tube portion; and
a tension clip, having a curved shape with at least one protruding portion engaged into the annular groove of the line spool in a way that the tension clip is non-rotatable relative to the line spool, and an elastic arm extending outwardly from the at least one protruding portion in a way that the elastic arm is in contact with the undulating portion of the dial disk.

2. The sounding structure of the spinning fishing reel as claimed in claim 1, wherein the undulating portion of the dial disk comprises a plurality of peaks and a plurality of troughs arranged alternately; the elastic arm of the tension clip has a distal end engaged into one of the troughs.

3. The sounding structure of the spinning fishing reel as claimed in claim 2, wherein the distal end of the elastic arm includes an axial segment extending into the one of the troughs, and the axial segment is parallel to the spindle.

4. The sounding structure of the spinning fishing reel as claimed in claim 1, further comprising an anti-rotation member disposed to the line spool and engaged with the tension clip.

5. The sounding structure of the spinning fishing reel as claimed in claim 4, wherein the anti-rotation member is a pillar, the annular groove of the line spool is located on an imaginary plane, and the anti-rotation member intersects with the imaginary plane.

6. The sounding structure of the spinning fishing reel as claimed in claim 4, wherein the tube portion of the line spool is installed with a line hooking member; the anti-rotation member is connected with the line hooking member and partially extends into the annular groove of the line spool.

7. The sounding structure of the spinning fishing reel as claimed in claim 1, wherein the tension clip comprises a striking member disposed on the elastic arm and engaged with the undulating portion of the dial disk.

8. The sounding structure of the spinning fishing reel as claimed in claim 1, wherein the tension clip comprises a stop arm extending from the at least one protruding portion and overlappingly engaging with the elastic arm.

9. The sounding structure of the spinning fishing reel as claimed in claim 1, further comprising a keyed washer sleeved onto the spindle and located between the tension clip and the line spool, and a brake washer sleeved onto the spindle and located between the keyed washer and the line spool.

10. The sounding structure of the spinning fishing reel as claimed in claim 1, wherein the tension clip is a C-shaped clip.
